(19) United States
(12) Patent Application Publication
(10) Pub. No.: US 2006/0105657 A1
(43) Pub. Date: May 18, 2006

(54) Microbial resistant kraft facing for fiberglass insulation

(76) Inventors: Harry B. Cline, Heath, OH (US); Kevin S. Guigley, Granville, OH (US); Kathleen M. Bullock, Zanesville, OH (US)

Correspondence Address: OWENS CORNING, 2790 COLUMBUS ROAD, GRANVILLE, OH, 43023, US

(21) Appl. No.: 10/986,743

(22) Filed: Nov. 12, 2004

(51) Int. Cl. B32B 27/04; B32B 17/02; B32B 5/02; B32B 17/04

(52) U.S. Cl. 442/180; 442/123; 442/172

(57) ABSTRACT

An insulation product that contains a Kraft paper facing treated with a combination of antimicrobial agents that imparts improved microbial resistance to the Kraft paper is provided. A preferred anti-microbial composition includes (1-[[2-(2,4-dichloropheyl)-4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol, and alkyl dimethylbenzyl ammonium saccharinate. The anti-microbial agents may each be present in the anti-microbial composition in an amount of from 50 to 1000 ppm. A biocide such as 2-(4-thiazolyl)benzimidazole may be added to the anti-microbial composition to impart additional microbial resistance. The Kraft paper may be adhered to the insulation by anti-microbially treated asphalt. The anti-microbial agent may be added to the asphalt in an amount of from 200-3000 ppm prior to applying the asphalt to the Kraft paper. In at least one exemplary embodiment, 2-n-octyl-4-isothiazolin-3-one is added to the asphalt. The insulation product formed is substantially free of bacteria, fungi, and molds.

### TECHNICAL FIELD AND INDUSTRIAL APPLICABILITY OF THE INVENTION

The present invention relates generally to the inhibition of microorganisms in an insulation product, and more particularly, to a Kraft paper facing for insulation batts that is treated with a combination of antimicrobial agents that imparts improved resistance to bacteria, fungi, and mold.

### BACKGROUND OF THE INVENTION

Bacteria, fungi, viruses, and other microorganisms are present throughout the environment. The species and numbers of microorganisms present in any situation depends on the general environment, the nutrients present, the amount of moisture available for the microorganisms, and on the humidity and temperature of the environment. Microorganisms are an essential part of ecological systems, industrial processes, and healthy human and animal functions, such as digestion. In other situations, however, the presence of microorganisms is highly undesirable because they can create odors and either damage or destroy a wide variety of materials. One such situation where the presence of microorganisms is detrimental is in fiber insulation products.

Fiber insulation is typically formed of mineral fibers (e.g., glass fibers) or organic fibers (e.g., polypropylene fibers), bound together by a binder material. The binder material gives the insulation product resiliency for recovery after packaging and provides stiffness and handleability so that the insulation product can be handled and applied as needed in insulation cavities of buildings. During manufacturing, the fiber insulation is cut into lengths to form individual insulation products, and the insulation products are packaged for shipping to customer locations. One typical insulation product is an insulation batt, which is suitable for use as wall insulation in residential dwellings or as insulation in the attic and floor insulation cavities in buildings.

Some insulation products have a facing on one of the major surfaces. In many cases, the facing acts as a vapor barrier, and in some insulation products, such as binderless products, the facing gives the product integrity for handleability. Facings that act as vapor barriers for insulation products are typically created with a layer of asphalt in conjunction with a Kraft paper or foil facing material. The asphalt coating is used both to adhere the layer of thermal insulation to the Kraft paper facing and to provide vapor barrier properties to the paper. The asphalt layer is applied in molten form and is pressed against the fibrous insulation material before hardening to bond the Kraft facing material to the insulation material. This asphalt and Kraft paper system has one advantage of being relatively inexpensive. However, this facing system lacks flexibility because the asphalt/Kraft paper layer is stiff.

Faced insulation products are installed with the facing placed flat on the edge of the insulation cavity, typically on the interior side of the insulation cavity. Insulation products where the facing is a vapor retarder are commonly used to insulate wall, floor, or ceiling cavities that separate a warm interior space from a cold exterior space. The vapor retarder is placed on one side of the insulation product to retard or prohibit the movement of water vapor through the insulation product.

Water vapor moves from an area of high vapor pressure to an area of low vapor pressure. Thus, in winter months, when the outside air is cooler than the inside air, the water vapor drive is from the interior of the building to the exterior of the building. In summer months, when the air conditioned air is cooler than the external air, the water vapor drive is from the exterior to the interior.

In winter months, when the vapor drive is from the interior to the exterior, it is desirable to place the vapor retarder facing on the inside of the insulation cavity (e.g., toward the inside of the building) to prevent condensation within the insulation product. However, during the summer months when the outside air is warmer than the inside air, this internal placement of the vapor retarder may result in condensation collecting in the insulation product. On the other hand, in summer months, it is desirable to place the vapor retarder facing on the exterior side of the insulation cavity (e.g., toward the outside of the building) to reduce the amount of water vapor entering the building during the air conditioning season. However, this external placement of the vapor retarder may result in the vapor cooling and condensing within the insulation in the winter. Thus, in geographic locations that have seasonal temperature changes, a vapor retarder facing placed on either the inside or the outside of the insulation cavity may result in condensation of water vapor into the insulation at some time during the year.

In addition, factors other than water vapor condensation can cause the insulation to become damp. For example, leaky roofs or pipes, flooding, or tears in the vapor barrier or facing may result in the insulation and/or kraft paper getting wet and promoting bacteria, mold, and fungal growth within the insulation and on the Kraft paper.

When water and/or other microbial nutrients contaminate fiberglass products, the water and nutrients provide a support medium for the growth of bacteria, fungi, and/or mold in and on the insulation products. The bacterial, fungal, and mold growth may cause unpleasant odors, discoloration in the fiberglass insulation, and a loss of vapor barrier properties for the Kraft paper facing. In addition, many people are susceptible to severe allergic responses when exposed to fungal spores that may be emitted from contaminated fiberglass insulation.

Thus, there exists a need in the art for an insulation system that inhibits bacterial, fungal, and mold growth in insulation products.

### SUMMARY OF THE INVENTION

It is an object of the invention to provide an insulation product that has improved resistance to bacteria, fungi, and molds. The insulation product contains a Kraft paper facing treated with a combination of antimicrobial agents. A preferred anti-microbial composition for treating the Kraft paper facing includes (1-[[2-(2,4-dichloropheyl)-4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol, and alkyl dimethylbenzyl ammonium saccharinate. The anti-microbial agents are present in an amount sufficient to effectively inhibit the growth of microorganisms. One or more biocides may also be added to the anti-microbial composition to impart additional microbial resistance. The Kraft paper may be adhered to the insulation by anti-microbially treated asphalt. In at least one exemplary embodiment, the asphalt is treated with 2-n-octyl-4-isothiazolin-3-one, zinc 2-pyrimidinethiol-1-oxide and/or 1-[2-(3,5-dichloro-phenyl)-4-propyl-[1,3]dioxolan-2-ylmethyl]-1H-[1,2,4]triazole. The anti-microbial agent(s) may be added to the asphalt in an amount of from 200-3000 ppm prior to applying the asphalt to the Kraft paper. The Kraft paper, the asphalt, or both the Kraft paper and the asphalt may be treated with anti-microbial agents and/or biocidal agents.

It is another object of the invention to provide a method for inhibiting the growth of microorganisms in a fiberglass insulation product. A biocidally effective amount of an anti-microbial composition may be applied to at least one surface of a facing of the insulation product. In preferred embodiments, the anti-microbial composition that is applied to the facing includes (1-[[2-(2,4-dichloropheyl)-4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol, and/or alkyl dimethylbenzyl ammonium saccharinate. One or more anti-microbial agents may be added to the asphalt adhering the facing to the insulation batt. In at least one exemplary embodiment, the asphalt is treated with 2-n-octyl-4-isothiazolin-3-one, zinc 2-pyrimidinethiol-1-oxide, and/or 1-[2-(3,5-dichloro-phenyl)-4-propyl-[1,3]dioxolan-2-ylmethyl]-1H-[1,2,4]triazole. The Kraft paper, the asphalt, or both the Kraft paper and the asphalt may be treated with anti-microbial agents and/or biocidal agents.

It is an advantage of the invention that the fiberglass insulation product that includes the treated Kraft paper and/or treated asphalt is substantially free of bacteria, fungi, and molds. As a result, the insulation product has a longer lifetime with no unpleasant odors or discoloration, and the Kraft paper does not demonstrate a loss of vapor barrier properties. In addition, the treated fiberglass insulation product reduces or eliminates the presence of mold spores, which can cause severe allergic responses in individuals.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

The present invention relates to an insulation system that contains a Kraft paper facing treated with a combination of antimicrobial agents that imparts improved microbial resistance to the Kraft paper. The combination of antimicrobial agents provides a synergistic effect not previously demonstrated in the art to provide an insulation product that is substantially free of bacteria, fungi, and molds. The term “substantially free of bacteria, fungi, and molds” as used herein is meant to indicate that the insulation product is free of bacteria, fungi, and molds or nearly free of bacteria, fungi, and molds.

Fibrous glass insulation products are generally formed of matted glass fibers bonded together by a cured thermoset polymeric material. The manufacture of glass fiber insulation may be carried out in a continuous process by fiberizing molten glass and immediately forming a fibrous glass batt on a moving conveyor. For example, glass may be melted in a tank and supplied to a fiber forming device such as a spinner or bushing. Glass fibers of random lengths are attenuated from the fiber forming device and blown downwardly within a forming chamber. The glass fibers may have a diameter from about 2 to about 9 microns and may have a length of from about ¼ of an inch to about 3 inches. Preferably, the glass fibers have a diameter of from about 3 to about 6 microns and a length of from about ½ of an inch to 1½ inches.

The fibers, while in transit in the forming chamber and while still hot from the drawing operation, may be sprayed with an aqueous binder by suitable spray applicators so as to result in a distribution of the binder throughout the formed batt of fibrous glass. The binder is not particularly limited, and may include a binder such as polyacrylic acid and phenolic based binders. These binders may include ingredients such as acrylic acid residues, glycerol, triethanolamine, lignin, pH modifiers, oil emulsions, and/or active and latent catalysts. Glass fibers having the uncured resinous binder adhered thereto may be gathered and formed into a batt on a perforated endless conveyor within the forming chamber with the aid of a vacuum drawn through the batt from below the forming conveyor. The residual heat from the glass fibers and the flow of air through the fibrous mat during the forming operation are generally sufficient to volatilize a majority of the water from the binder before the fibers exit the forming chamber, thereby leaving the remaining components of the binder on the fibers as a viscous or semi-viscous high-solids liquid.

The coated fibrous mat, which is formed in a compressed state due to the tremendous flow of air through the mat in the forming chamber, is then transferred out of the forming chamber to a transfer zone where the mat vertically expands due to the resiliency of the glass fibers. The expanded batt is then heated, such as by conveying the batt through a curing oven where heated air is blown through the batt to evaporate any remaining water in the binder, cure the binder, and rigidly bond the fibers together. The cured binder imparts strength and resiliency to the insulation product.

Also, in the curing oven, the insulation product is compressed to form the product into a blanket, batt, or board. Flights or rollers above and below the batt compress the batt to give the finished product a predetermined thickness and surface finish. The curing oven may be operated at a temperature from about 200° C. to about 325° C. Preferably, the temperature of the curing oven ranges from about 250° C. to about 300° C. The batt may remain within the oven for a period of time from about 30 seconds to about 3 minutes to sufficiently cure the binder, and preferably from about 45 seconds to about 1½ minutes.

Fibrous glass having a cured, rigid binder matrix emerges from the oven in the form of a batt, which may be further compressed for packaging and shipping. When unconstrained, the batt will substantially fully recover its as-made vertical dimension. By way of example, a fibrous glass batt which is about 1¼ inches thick as it exits the forming chamber may expand to a vertical thickness of about 9 inches in the transfer zone, and may be compressed to a vertical thickness of about 6 inches in the curing oven.

A facing material, such as Kraft paper or a foil-scrim-Kraft paper laminate, may then be adhered to at least one major surface of the insulation batt by a bonding agent. Other types of paper such as recycled paper or calendared paper may optionally be used as the facing material. Suitable bonding agents include adhesives, polymeric resins, asphalt, and other bituminous materials that can be coated or otherwise applied to the facing sheet. Examples of polymeric resins used to adhere the facing material to the insulation material include, but are not necessarily limited to, polyethylene and/or copolymers of polyethylene such as poly(ethylene-co-vinyl acetate). When a polymeric resin is used as the bonding agent, the Kraft paper may be coated with the polymer resin and heated prior to pressing the coated paper to the insulation batt. In at least one exemplary embodiment, the bonding agent is asphalt. In such an embodiment, molten asphalt may be applied to one side of the facing. The facing is then pressed against the fibrous insulation material before hardening to bond the facing material to the glass fiber insulation.

As noted above, the presence of water, dust, and/or other microbial nutrients in an insulation product may support the growth and proliferation of microbial organisms. Bacterial and/or mold growth in the insulation may cause odor and discoloration of the insulation product and deterioration of the vapor barrier properties of the Kraft paper. To inhibit the growth of unwanted microorganisms such as bacteria, fungi, and/or mold in the insulation product, the facing material and/or the fibrous insulation may be treated with one or more anti-microbial agents and/or biocides.

Anti-microbial agents may be sprayed directly onto the insulation product or they may be incorporated into the binder system and sprayed onto the individual glass fibers of the insulation product such as is disclosed in U.S. patent application Ser. No. 10/319,154 filed Dec. 13, 2002 to Delaviz et al. entitled “Method For The Addition Of Anti-Microbial Compounds To Fiberglass Insulation Products.” In addition, or as an alternative to placing an anti-microbial agent on the fibrous insulation, anti-microbial agents may be incorporated into the Kraft paper by adding anti-microbial agents in the slurry during the paper making process, such as is disclosed in U.S. Patent Publication No. 2003/0234068 to Swofford et al. Anti-microbial agents may also be applied to the surface of fiberglass, wood, metal, or plastic media (e.g., the surface of air ducts) as disclosed in, for example, U.S. Pat. Nos. 5,066,328, 5,487,412, 5,474,739, and 5,939,203.

At least one aspect of the present invention focuses on the inhibition of microbial growth on the facing material, which, in preferred embodiments, is Kraft paper. The inventors have surprisingly discovered a combination of anti-microbial agents that act in a synergistic manner to resist microbial growth on the facing material. It is to be noted that although other facing materials may be utilized in conjunction with the present invention, the invention is described herein with reference to Kraft paper.

Non-limiting examples of suitable anti-microbial agents that may be used to impart resistance to microbial growth in accordance with the present invention are set forth in Table 1. The anti-microbial agents listed in Table 1 may be used alone or in any combination to form an anti-microbial composition.

TABLE 1
Antimicrobial Agents for Treating Kraft Paper

Antimicrobial Agent

| | |
|---|---|
| (1-[[2-(2,4-dichloropheyl)-4-propyl-1,3- | Microban ® S2140 |
| diololan-2-yl]-methyl]-1H-1,2,4-triazole | |
| α-(2-(4-chlorphenyl)ethyl)-α-(1-1- | Microban ® S2142 |
| dimethylethyl)-1H-1,2,4-triazole-1-ethanol | |
| alkyl dimethylbenzyl ammonium saccharinate | Microban ® S2176 |
| zinc 2-pyrimidinethiol-1-oxide | Zinc Omadine ® |
| 1-[2-(3,5-dichloro-phenyl)-4-propyl- | Propiconazol ® |
| [1,3]dioxolan-2-ylmethyl]-1H-[1,2,4]triazole | |
| 4,5-dichloro-2-octyl-isothiazolidin-3-one, 2- | DCOIT |
| octyl-isothiazolidin-3-one | |
| 2-octyl-isothiazolidin-3-one | OIT |
| 5-chloro-2-(2,4-dichloro-phenoxy)-phenol | Tricolosan ® |
| 2-thiazol-4-yl-1H-benzoimidazole | Thiabendazole ® |
| 1-(4-chloro-phenyl)-4,4-dimethyl-3- | Tebuconazole ® |
| [1,2,4]triazol-4-ylmethyl-pentan-3-ol | |
| 10,10′ oxybisphenoxarsine | OBPA |
| 1-(diiodo-methanesulfonyl)-4-methyl-benzene | Amical ® |

Preferred anti-microbial compositions for imparting an improved resistance to microbial growth on Kraft paper include any combination of (1-[[2-(2,4-dichloropheyl)-4-propyl-1,3-diololan-2-yl]-methyl]-1H-1,2,4-triazole; α-(2-(4-chlorphenyl)ethyl)-α-(1-1-dimethylethyl)-1H-1,2,4-triazole-1-ethanol; and/or alkyl dimethylbenzyl ammonium saccharinate. Each of the anti-microbials that form the anti-microbial composition is present in an amount sufficient to effectively inhibit the growth of microorganisms. Such an effective amount (e.g., biocidally effective amount) will vary depending on the specific anti-microbial agent used. It is preferred that each anti-microbial agent is present in the composition in an amount greater than 50 ppm, preferably in an amount of from 50 to 1000 ppm, and more preferably in an amount of from 50-300 ppm. In addition, one or more biocides such as 2-(4-thiazolyl)benzimidazole (Metasol® TK-25AD commercially available from Bayer), and/or Busan 1280 (Buckman) may be added to the anti-microbial composition.

The Kraft paper may be surface treated with the anti-microbial composition, such as by spraying, dipping, misting, or roll coating. The Kraft paper may have a thickness corresponding to a weight of from 20-70 lbs/3000 ft², preferably from 35-38 lbs/3000 ft². Coating or treating the Kraft paper either before or after its attachment to the insulation material is within the purview of the invention, although it is preferred that the anti-microbial composition be applied to the Kraft paper prior to attaching the Kraft paper to the insulation material. One or both sides of the Kraft paper may be treated with the anti-microbial composition. When the Kraft paper is treated with an inventive anti-microbial composition, the Kraft paper demonstrates substantially no microbial growth when tested according to ASTM C1338 and ASTM G21. As used herein, the phrase “substantially no microbial growth” is meant to indicate that there is no microbial growth or almost no microbial growth.

In at least one embodiment of the invention, the Kraft paper is adhered to the insulation by asphalt, and the asphalt is treated with at least one anti-microbial agent. The asphalt may be treated alone or in conjunction with the Kraft paper facing. A non-exhaustive list of suitable anti-microbial agents that may be used to treat asphalt in accordance with the present invention is set forth in Table 2. Each of the anti-microbial agents listed in Table 2 can survive temperatures at least as high as 350° F., and preferably as high as 425° F.

TABLE 2
Antimicrobial Agents for Treating Asphalt

| Antimicrobial Agent | |
|---|---|
| 2-n-octyl-4-isothiazolin-3-one | Microban ® LB6 |
| zinc 2-pyrimidinethiol-1-oxide | Zinc Omadine ® |
| 1-[2-(3,5-dichloro-phenyl)-4-propyl- | Propiconazol ® |
| [1,3]dioxolan-2-ylmethyl]-1H-[1,2,4]triazole | |
| 4,5-dichloro-2-octyl-isothiazolidin-3-one, 2- | DCOIT |
| octyl-isothiazolidin-3-one | |
| 2-octyl-isothiazolidin-3-one | OIT |
| 5-chloro-2-(2,4-dichloro-phenoxy)-phenol | Tricolosan ® |
| 2-thiazol-4-yl-1H-benzoimidazole | Thiabendazole ® |
| 1-(4-chloro-phenyl)-4,4-dimethyl-3- | Tebuconazole ® |
| [1,2,4]triazol-4-ylmethyl-pentan-3-ol | |
| 10,10′ oxybisphenoxarsine | OBPA |
| 1-(diiodo-methanesulfonyl)-4-methyl-benzene | Amical ® |

The anti-microbial agents listed in Table 2 may be used alone or in any combination to anti-microbially treat the asphalt. In preferred examples, the anti-microbial agent is Microban® LB6, an anti-microbial product commercially available from Microban Products Company. An anti-microbial agent may be added to the asphalt in an amount of from 200-3000 ppm prior to applying the asphalt to the Kraft paper, and preferably in an amount of from 1000-2000 ppm. It is within the purview of the invention to treat the Kraft paper, the asphalt, or both the Kraft paper and the asphalt with anti-microbial agents and/or biocidal agents to achieve improved resistance to the growth of unwanted microorganisms.

It is an advantage of the invention that the fiberglass insulation product formed from the treated Kraft paper and/or treated asphalt is substantially free of bacteria, fungi, and molds. As a result, the insulation product has a longer lifetime with no unpleasant odors and no discoloration, and the Kraft paper does not demonstrate a loss of vapor barrier properties. In addition, the treated fiberglass insulation product reduces or eliminates the presence of mold spores, which are known to cause severe allergic responses in individuals.

Having generally described this invention, a further understanding can be obtained by reference to certain specific examples illustrated below which are provided for purposes of illustration only and are not intended to be all inclusive or limiting unless otherwise specified.

### EXAMPLES

General Criteria for ASTM C1338

Mold Spores Tested: Aspergillus flavus, Aspergillus niger, Aspergillus versicolor, Chaetomium globosum, Penicillium funiculosum

Nutrients Salt Agar: None

Incubation Temperature: 30+/−2° C.

Incubation Relative Humidity: 95+/−4%

Incubation Time: 28 days+/−8 hours

Comparative Item: Birch tongue depressor

Inspection: 40× magnification

Criterion: Fail—growth greater than comparative item/Pass—growth not greater than comparative item

General Criteria for ASTM G21

Mold Spores Tested: Apsergillus niger, Aureobasidium pullulans, Chaetomium globosum, Gliocladium virens, Penicillium pinophilum

Nutrients Salt Agar: Ammonium nitrate, ferrus sulfate, magnesium sulfate, manganous sulfate, potassium dihydrogen orthophosphate, potassium monohydrogen orthophosphate, sodium chloride, water

Incubation Temperature: 28-30° C.

Incubation Relative Humidity: Not less than 85%

Incubation Time: 28 days

Comparative Item: None

Inspection: Visual

Criterion: 0=none; 1=trace, less than 10%; 2=light growth (10-30%); 3=medium growth (30-60%); 4=heavy growth (60% or greater); trace or no growth must be confirmed by microscopic observation.

General Criteria for Set Points

Information regarding the set points utilized in the following examples is set forth in Table 3. Each of the set points (SP-1-SP-6) contain an approximately equal combination of 1-[[2-(2,4-dichloropheyl)4-propyl-1,3-diololan-2-yl]-methyl]-1H-1,2,4-triazole (Microban® S2140); α-(2-(4-chlorphenyl)ethyl)-α-(1-1-dimethylethyl)-1H-1,2,4-triazole-1-ethanol (Microban® S2142); and alkyl dimethylbenzyl ammonium saccharinate (Microban® S2176).

TABLE 3

| Set Point⁽¹⁾ | Kraft Paper | Treatment | Average PPM⁽²⁾ |
|---|---|---|---|
| SP-1 | 35 lbs/3000 ft² | One side | 106 |
| SP-2 | 35 lbs/3000 ft² | Both sides | 220 |
| SP-3 | 38 lbs/3000 ft² | One side | 117 |
| SP-4 | 38 lbs/3000 ft² | One side | 46 |

⁽¹⁾Combination of 1-[[2-(2,4-dichloropheyl)4-propyl-1,3-diololan-2-yl]-methyl]-1H-1,2,4-triazole (Microban ® S2140); α-(2-(4-chlorphenyl)ethyl)-α-(1-1-dimethylethyl)-1H-1,2,4-triazole-1-ethanol (Microban ® S2142); and alkyl dimethylbenzyl ammonium saccharinate (Microban ® S2176)
⁽²⁾The results are an average loading for each additive in the set point

### Example 1

### Testing of Kraft Paper for Fungi Resistance According to ASTM C1338

White Kraft paper treated with MicrobeGuard (a silver zeolite commercially available from MicrobeGuard Corporation) on the dull side of the paper was tested according to ASTM 1338. Aspergillus niger (American Type Culture Collection (ATCC) 9642), Aspergillus versicolor (ATCC 11730), Chaetomium globosum (ATCC 6205), Aspergillus flavus (ATCC 9643) and Penicillium funiculosum (ATCC 11 797) were harvested and the viability of each fungal culture was confirmed. The five fungal cultures were used to prepare a mixed spore suspension. Inoculum viability controls were inoculated along with the test samples (white Kraft Paper treated with MicrobeGuard on the dull side of the paper) and comparative controls (white Birch tongue depressors (20×150 mm in size)). Duplicate samples were tested.

After pre-conditioning, the test samples and controls were inoculated with the mixed fungal spore suspension. Inoculation was accomplished by spraying the suspension in the form of a fine mist from an atomizer. The test materials were sprayed until the initiation of droplet coalescence. Incubation was conducted at 86±4° F. and a relative humidity of 95±4% for a time period of 28 days.

The inoculum and controls were examined after seven days of incubation. The samples and comparative controls were evaluated on incubation day 28 using a binocular stereoscopic microscope at 160× magnification. All fungal strain viability controls and the inoculum after 7 and 28 days of incubation showed copious amounts of fungal growth indicating a valid fungal resistance test. The comparative Birch controls showed slight fungal growth covering 80% of the surface area (++growth).

Kraft paper that had growth greater than the growth on the tongue depressors were considered to have failed the test. Kraft paper that did not have growth greater than that on the tongue depressors were considered to have passed the test. It was observed that after 28 days of incubation, there was no fungal growth on the treated Kraft paper. Thus, it was concluded that the Kraft paper treated with MicrobeGuard passed the standards set by ASTM C1338.

### Example 2

### Testing of Kraft Paper for Fungi Resistance According to ASTM G21

White Kraft paper treated with MicrobeGuard (a silver zeolite commercially available from MicrobeGuard Corporation) on the dull side of the paper was tested according to ASTM G21. Spore suspensions of Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233) were prepared and tested for viability. Nutrient salts agar was poured into sterile dishes to provide a solidified agar layer from 3-6 mm in depth. The nutrient salts agar contained agar, ammonium nitrate, ferrous sulfate, magnesium sulfate, manganous sulfate, potassium dihydrogen orthophosphate, potassium monohydrogen orthophosphate, sodium chloride, and water.

After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope. The rating system set forth in Table 4 was used to rank the growth on the agar.

TABLE 4

| Amount of Growth | Rating |
|---|---|
| None | 0 |
| Traces of Growth | 1 |
| (less than 10%) | |
| Light Growth | 2 |
| (10-30%) | |
| Medium Growth | 3 |
| (30-60%) | |
| Heavy Growth | 4 |
| (60% to complete coverage) | |

Microscopic examination of the Kraft paper after 28 days of incubation showed fungal growth over 60% of the surface and was given a rating of “4”. It was concluded that white Kraft paper treated with MicrobeGuard on the dull side was able to support vigorous growth of fungi when tested according to ASTM G21, and thus failed the test.

### Example 3

### Testing of Asphalt-Coated Kraft Paper for Fungi Resistance According to ASTM C1338

Asphalt-coated Kraft paper was tested according to ASTM C1338. Aspergillus niger (American Type Culture Collection 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (asphalt-coated Kraft paper) and comparative controls (white Birch tongue depressors (20×150 mm in size)). Duplicate samples were tested.

The samples and controls were inoculated with the mixed fungal spore suspension after preconditioning. Inoculation was accomplished by spraying the suspension in the form of a fine mist from an atomizer. The test materials were sprayed until the initiation of droplet coalescence. Incubation was conducted at 86±4° F. and a relative humidity of 95±4% for 28 days.

The inoculum and strain controls were examined after seven days of incubation. The samples and comparative controls were evaluated the 28th day of testing using a binocular stereoscopic microscope (160× magnification). All fungal strain viability controls and the inoculum after 7 and 28 days of incubation showed copious amounts of fungal growth, thus indicating a valid fungal resistance test. The comparative Birch controls showed slight fungal growth covering 80% of the surface area (e.g., ++growth).

Microscopic examination of the test samples was conducted after 28 days of incubation. The standard for determining a rating of the fungal growth on the samples is set forth in Table 5. The observation results are set forth in Table 6.

TABLE 5

| Amount of Growth | Rating |
|---|---|
| No Growth | 0 |
| Scant Growth | + |
| Moderate Growth | ++ |
| Heavy Growth | +++ |
| Confluent Growth Over | ++++ |
| Entire Surface | |

TABLE 6

| Sample | Asphalt | Kraft Paper |
|---|---|---|
| Asphalt coated paper treated on one side | + | 0 |
| Medium level SP-1 | | |
| Asphalt coated paper treated on both sides | + | 0 |
| High level SP-2 | | |
| Asphalt coated paper treated on one side | + | + |
| Low level SP-3 | | |
| Asphalt coated paper treated on both sides | + | 0 |
| with Metasol TK 25AD^{(a)} | | |
| Kraft paper treated on one side | | 0 |
| Medium level SP-1 | | |
| Kraft paper treated on both sides | | 0 |
| High level SP-2 | | |
| Kraft paper treated on one side | | 0 |
| Low level SP-3 | | |
| Paper treated on both sides | | + |
| with Metasol TK 25AD^{(a)} | | |

^{(a)}2-(4-thiazolyl)benzimidazole (commercially available from Bayer)

Samples that had growth greater than the growth on the tongue depressors were considered to have failed the test. Samples that did not have growth greater than that on the tongue depressors were considered to have passed the test. It was observed that after 28 days of incubation, there was little to no fungal growth on the Kraft paper, and only scant growth on the asphalt. None of the Kraft paper and asphalt samples exceeded the fungal growth on the Birch tongue depressors (control). Thus, it was concluded that the Kraft paper and asphalt treated with 1-[[2-(2,4-dichloropheyl)4-propyl-1,3-diololan-2-yl]-methyl]-1H-1,2,4-triazole (Microban® S2140), α-(2-(4-chlorphenyl)ethyl)-α-(1-1-dimethylethyl)-1H-1,2,4-triazole-1-ethanol (Microban® S2142), and alkyl dimethylbenzyl ammonium saccharinate (Microban® S2176), or 2-(4-thiazolyl)benzimidazole (Metasol TK 25AD) passed the standards given by ASTM C1338.

### Example 4

### Testing to Determine Resistance of Synthetic Polymeric Materials to Fungi According to ASTM G21

Asphalt-coated Kraft paper was tested according to ASTM G21. Spore suspensions of Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233) were prepared and tested for viability. Nutrient salts agar was poured into sterile dishes to provide a solidified agar layer from 3-6 mm in depth. The nutrient salts agar contained agar, ammonium nitrate, ferrous sulfate, magnesium sulfate, manganous sulfate, potassium dihydrogen orthophosphate, potassium monohydrogen orthophosphate, sodium chloride, and water.

After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope. The standard for determining a rating of the fungal growth on the samples is set forth in Table 7. The observation results are set forth in Table 8.

TABLE 7

| Observed Growth on Specimens | Rating |
|---|---|
| None | 0 |
| Traces of Growth | + |
| (less than 10%) | |
| Light Growth | ++ |
| (10-30%) | |
| Medium Growth | +++ |
| (30-60%) | |
| Heavy Growth | ++++ |
| (60%-complete coverage) | |

TABLE 8

| Sample | Asphalt | Kraft Paper |
|---|---|---|
| Asphalt coated Kraft paper treated on one side | ++++ | ++++ |
| Medium level SP-1 | | |
| Asphalt coated Kraft paper treated on both sides | ++++ | ++++ |
| High level SP-2 | | |
| Asphalt coated Kraft paper treated on one side | ++++ | ++++ |
| Low level SP-3 | | |
| Asphalt coated Kraft paper treated on both sides | ++++ | ++++ |
| with Metasol TK 25AD^{(a)} | | |
| Kraft paper treated on one side | | 0 |
| Medium level SP-1 | | |
| Kraft paper treated on both sides | | 0 |
| High level SP-2 | | |
| Kraft paper treated on one side | | 0 |
| Low level SP-3 | | |
| Kraft paper treated on one side | | ++ |
| Low level SP-4 | | |
| Kraft paper treated on both sides | | ++ |
| with Metasol TK 25AD^{(a)} | | |

^{(a)}2-(4-thiazolyl)benzimidazole (commercially available from Bayer)

In each of the samples where the Kraft paper was coated with asphalt, heavy fungal growth (++++) resulted. Thus, it was concluded that asphalt coated Kraft paper failed ASTM G21. It was also concluded that the some of the treated Kraft papers treated with 1-[[2-(2,4-dichloropheyl)-4-propyl-1,3-diololan-2-yl]-methyl]-1H-1,2,4-triazole (Microban® S2140), α-(2-(4-chlorphenyl)ethyl)-α-(1-1-dimethylethyl)-1H-1,2,4-triazole-1-ethanol (Microban® S2142), and alkyl dimethylbenzyl ammonium saccharinate (Microban® S2176 exhibited no mold growth, i.e., those samples indicating “0” fungal growth in Table 8, and passed the test standards according to ASTM G-21.

### Example 5

### Testing of Oxidized Asphalt for Fungi Resistance According to ASTM C1338

Oxidized asphalt (Trumbull asphalt 1309 from Detroit) was tested according to ASTM C1338. Aspergillus niger (ATCC 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (oxidized asphalt 1309) and comparative controls (white Birch tongue depressors (20×150 mm in size)). Duplicate samples were tested.

After pre-conditioning, the samples and controls were inoculated with the mixed fungal spore suspension. Inoculation was accomplished by spraying the suspension in the form of a fine mist from an atomizer. The test materials were sprayed until the initiation of droplet coalescence. Incubation was conducted at 86±4° F. and a relative humidity of 95±4% for 28 days.

The inoculum and strain controls were examined after seven days of incubation. The samples and comparative controls were evaluated on the 28th day of testing using a binocular stereoscopic microscope at 160× magnification. All fungal strain viability controls and the inoculum after 7 and 28 days of incubation showed copious amounts of fungal growth indicating a valid fungal resistance test. The comparative Birch controls showed slight fungal growth covering 80% of the surface area (e.g., ++growth).

Oxidized asphalt samples that had growth greater than the growth on the tongue depressors (controls) were considered to have failed the test. Oxidized asphalt samples that had less fungal growth than the growth on the tongue depressors were considered to have passed the test. Microscopic examination of the oxidized asphalt test samples conducted after 28 days of incubation showed no fungal growth. Thus, it was concluded that oxidized asphalt passed the standards set forth in ASTM C 1338.

### Example 6

### Testing of Oxidized Asphalt for Fungi Resistance According to ASTM G21

Oxidized asphalt (Trumbull asphalt 1309 from Detroit) was tested according to ASTM G21 to determine if oxidized asphalt 1309 would support the growth of fungi. Five fungal cultures were tested, namely, Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233). Spore suspensions of each of the five fungi were prepared and tested for viability.

Nutrient salts agar (ammonium nitrate, ferrous sulfate, magnesium sulfate, manganous sulfate, potassium dihydrogen orthophosphate, potassium monohydrogen orthophosphate, sodium chloride, and water) were poured into sterile dishes to provide a solidified agar layer of from 3-6 mm in depth. After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope.

The standard for determining a rating of the fungal growth on the samples is set forth in Table 7 Microscopic examination of the oxidized asphalt showed trace fungal growth (less than 10% fungal growth). Thus, it was concluded that oxidized asphalt passed the ASTM G21 fungal resistance test.

### Example 7

### Testing of Oxidized Asphalt with 1% Zinc Borate for Fungi Resistance According to ASTM 1338

Oxidized asphalt (Trumbull asphalt 1309 from Detroit) with 1% zinc borate was tested for fungi resistance according to ASTM C1338. Aspergillus niger (ATCC 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (oxidized asphalt (Trumbull asphalt 1309 from Detroit) with 1% zinc borate) and comparative controls (white Birch tongue depressors (20×150 mm in size)). Duplicate samples were tested.

The samples and controls were inoculated with the mixed fungal spore suspension after pre-conditioning. Inoculation was accomplished by spraying the suspension in the form of a fine mist from an atomizer. The test materials were sprayed until the initiation of droplet coalescence. Incubation was conducted for 28 days at 86±4° F. and a relative humidity of 95±4%.

The inoculum and strain controls were examined after seven days of incubation. The samples and comparative controls were evaluated on the 28th day of testing using a binocular stereoscopic microscope at 160× magnification. All fungal strain viability controls and the inoculum after 7 and 28 days of incubation showed copious amounts of fungal growth indicating a valid fungal resistance test. The comparative Birch controls showed slight fungal growth covering 80% of the surface area (++growth).

Microscopic examination of the oxidized asphalt test samples was conducted after 28 days of incubation. No fungal growth was observed. Thus, it was concluded that oxidized asphalt with 1% zinc borate passed the fungal resistance standards set forth in ASTM C1338.

### Example 8

### Testing of Oxidized Asphalt with 1% Zinc Borate for Fungi Resistance According to ASTM G21

Oxidized asphalt (Trumbull asphalt 1309 from Detroit) containing 1% zinc borate was tested according to ASTM G21 to determine whether the zinc-borate containing oxidized asphalt will support the growth of fungi. Spore suspensions of Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233) were prepared and tested for viability. Nutrient salts agar was poured into sterile dishes to provide a solidified agar layer from 3-6 mm in depth. The nutrient salts agar contained agar, ammonium nitrate, ferrous sulfate, magnesium sulfate, manganous sulfate, potassium dihydrogen orthophosphate, potassium monohydrogen orthophosphate, sodium chloride, and water.

After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope. The standard for determining a rating of the fungal growth on the samples is set forth in Table 4. Microscopic examination of the oxidized asphalt test samples after 28 days of incubation showed a fungal growth rating of from “1”-“2”. Thus, it was concluded that oxidized asphalt (Trumbull asphalt 1309 from Detroit) with 1% zinc borate supports approximately 10-30% growth of the test fungi.

### Example 9

### Testing of Various Asphalt-Coated Kraft Papers for Fungal Resistance According to ASTM C1338

Various asphalt-coated Kraft paper samples (shown in Table 10) were tested according to ASTM C 1338 to determine if the samples could support fungal growth. Aspergillus niger (ATCC 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (asphalt-coated Kraft paper samples set forth in Table 10) and comparative controls (white Birch tongue depressors (20×150 mm in size)). Duplicate samples were tested.

The samples and controls were inoculated with the mixed fungal spore suspension after pre-conditioning. Inoculation was accomplished by spraying the suspension in the form of a fine mist from an atomizer. The test materials were sprayed until the initiation of droplet coalescence. Incubation was conducted at 86±4° F. and a relative humidity of 95±4% for 28 days.

The inoculum and strain controls were examined after seven days of incubation. The samples and comparative controls were evaluated the 28th day of testing using a binocular stereoscopic microscope (160× magnification). All fungal strain viability controls and the inoculum after 7 and 28 days of incubation showed copious amounts of fungal growth indicating a valid fungal resistance test. The comparative Birch controls showed slight fungal growth covering 80% of the surface area (++growth).

Microscopic examination of the test samples was conducted after 28 days of incubation. The standard for determining a rating of the fungal growth on the samples is set forth in Table 9. The observation results are set forth in Table 10.

TABLE 9

| Amount of Growth | Rating |
|---|---|
| No Growth | 0 |
| Scant Growth | + |
| Moderate Growth | ++ |
| Heavy Growth | +++ |
| Confluent Growth Over | ++++ |
| Entire Surface | |

TABLE 10

| Amount of | Amount of | |
|---|---|---|
| Growth | Growth | |
| On Asphalt | On Kraft Paper | Material |
| 0 | + | SP 1 coated with asphalt (no treatment) |
| + | + | SP 2 coated with asphalt (no treatment) |
| + | + | SP 3 coated with asphalt (no treatment) |
| 0 | 0 | SP 1 coated with asphalt treated with |
| | | Microban R10000-999^{(a)} (2000 ppm) |
| + | 0 | SP 2 coated with asphalt treated with |
| | | Microban R10000-999 (2000 ppm) |
| ++ | 0 | SP 3 coated with asphalt treated with |
| | | Microban R10000-999 (2000 ppm) |
| 0 | 0 | SP 1 coated with asphalt treated with |
| | | Microban R10000-999 (3000 ppm) |
| 0 | 0 | SP 2 coated with asphalt (treated with |
| | | Microban R10000-999 (3000 ppm)) |
| + | + | SP 3 coated with asphalt treated with |
| | | Microban R10000-999 (3000 ppm) |
| 0 | 0 | SP 1 coated with asphalt treated with |
| | | Microban LB-6^{(b)} (2000 ppm) |
| 0 | 0 | SP 2 coated with asphalt treated with |
| | | Microban LB-6 (2000 ppm) |
| 0 | 0 | SP 3 coated with asphalt treated with |
| | | Microban LB-6 (2000 ppm) |
| 0 | 0 | SP 1 coated with asphalt treated with |
| | | Microban LB-6 (3000 ppm) |
| 0 | 0 | SP 2 coated with asphalt treated with |
| | | Microban LB-6 (3000 ppm) |
| 0 | 0 | SP 3 coated with asphalt treated with |
| | | Microban LB-6 (3000 ppm) |
| + | 0 | SP 1 coated with asphalt treated with |
| | | Arch Zinc Omadine (2000 ppm) |
| + | 0 | SP 2 coated with asphalt treated with |
| | | Arch Zinc Omadine (2000 ppm) |
| ++ | ++ | SP 3 coated with asphalt treated with |
| | | Arch Zinc Omadine (2000 ppm) |
| 0 | 0 | SP 1 coated with asphalt treated with |
| | | Arch Zinc Omadine (3000 ppm) |
| + | 0 | SP 2 coated with asphalt treated with |
| | | Arch Zinc Omadine (3000 ppm) |
| ++ | 0 | SP 3 coated with asphalt treated with Arch |
| | | Zinc Omadine (3000 ppm) |
| + | 0 | SP 1 coated with asphalt treated with |
| | | Cupric Sulfate at 1% |
| 0 | 0 | SP 2 coated with asphalt treated with |
| | | Cupric Sulfate at 1% |
| + | ++ | SP 3 coated with asphalt treated with |
| | | Cupric Sulfate at 1% |
| 0 | 0 | SP 1 coated with asphalt treated with |
| | | Cupric Sulfate at 3% |
| 0 | 0 | SP 2 coated with asphalt treated with |
| | | Cupric Sulfate at 3% |
| ++ | 0 | SP 3 coated with asphalt treated with |
| | | Cupric Sulfate at 3% |
| 0 | 0 | CEI treated Kraft paper^{(c)} |
| 0 | 0 | CEI treated Kraft paper heated for 1½ |
| | | minutes in an oven at 350° F. |

^{(a)}a chlorinated phenoxy (Microban Products Company)
^{(b)}2-n-Octyl-4-isothiazolin-3-one (Microban Products Company)
^{(c)}Kraft paper coated with polyethylene and carbon black and treated with a preservative

It was determined that all of the samples in Table 10 did not exceed the amount of fungal growth on the Birch tongue depressor (control). Therefore, it was concluded that the samples tested passed the testing standards of ASTM C1338.

### Example 10

### Testing of Various Asphalt-Coated Kraft Papers for Fungal Resistance According to ASTM G21

Various asphalt-coated Kraft paper samples (shown in Table 12) were tested according to ASTM G21 to determine if the samples could support fungal growth. Spore suspensions of Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233) were prepared and tested for viability. Nutrient salts agar was poured into sterile dishes to provide a solidified agar layer from 3-6 mm in depth. The nutrient salts agar contained agar, ammonium nitrate, ferrous sulfate, magnesium sulfate, manganous sulfate, potassium dihydrogen orthophosphate, potassium monohydrogen orthophosphate, sodium chloride, and water.

After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope. The standard for determining a rating of the fungal growth on the samples is set forth in Table 11. The observation results are set forth in Table 12.

TABLE 11

| Amount of Growth | Rating |
|---|---|
| None | 0 |
| Traces of Growth | + |
| (less than 10%) | |
| Light Growth | ++ |
| (10-30%) | |
| Medium Growth | +++ |
| (30-60%) | |
| Heavy Growth | ++++ |
| (60% to complete coverage) | |

TABLE 12

| Amount of | Amount of | |
|---|---|---|
| Growth | Growth | |
| On Asphalt | On Kraft Paper | Material |
| 0 | ++ | SP 1 coated with asphalt (no treatment) |
| ++ | ++++ | SP 2 coated with asphalt (no treatment) |
| ++++ | ++++ | SP 3 coated with asphalt (no treatment) |
| + | + | SP 1 coated with asphalt treated with |
| | | Microban R10000-999^{(a)} (2000 ppm) |
| ++ | ++ | SP 2 coated with asphalt treated with |
| | | Microban R10000-999 (2000 ppm) |
| ++++ | ++++ | SP 3 coated with asphalt treated with |
| | | Microban R10000-999 (2000 ppm) |
| + | ++ | SP 1 coated with asphalt treated with |
| | | Microban R10000-999 (3000 ppm) |
| ++ | +++ | SP 2 coated with asphalt (treated with |
| | | Microban R10000-999 (3000 ppm)) |
| ++++ | ++++ | SP 3 coated with asphalt treated with |
| | | Microban R10000-999 (3000 ppm) |
| 0 | 0 | SP 1 coated with asphalt treated with |
| | | Microban LB-6^{(b)} (2000 ppm) |
| 0 | 0 | SP 2 coated with asphalt treated with |
| | | Microban LB-6 (2000 ppm) |
| ++ | +++ | SP 3 coated with asphalt treated with |
| | | Microban LB-6 (2000 ppm) |
| 0 | 0 | SP 1 coated with asphalt treated with |
| | | Microban LB-6 (3000 ppm) |
| 0 | 0 | SP 2 coated with asphalt treated with |
| | | Microban LB-6 (3000 ppm) |
| ++ | +++ | SP 3 coated with asphalt treated with |
| | | Microban LB-6 (3000 ppm) |
| 0 | ++ | SP 1 coated with asphalt treated with |
| | | Arch Zinc Omadine (2000 ppm) |
| +++ | ++++ | SP 2 coated with asphalt treated with |
| | | Arch Zinc Omadine (2000 ppm) |
| +++ | +++ | SP 3 coated with asphalt treated with |
| | | Arch Zinc Omadine (2000 ppm) |
| + | ++ | SP 1 coated with asphalt treated with |
| | | Arch Zinc Omadine (3000 ppm) |
| ++ | ++++ | SP 2 coated with asphalt treated with |
| | | Arch Zinc Omadine (3000 ppm) |
| +++ | +++ | SP 3 coated with asphalt treated with Arch |
| | | Zinc Omadine (3000 ppm) |
| 0 | ++ | SP 1 coated with asphalt treated with |
| | | Cupric Sulfate at 1% |
| ++ | +++ | SP 2 coated with asphalt treated with |
| | | Cupric Sulfate at 1% |
| ++++ | ++++ | SP 3 coated with asphalt treated with |
| | | Cupric Sulfate at 1% |
| ++ | +++ | SP 1 coated with asphalt treated with |
| | | Cupric Sulfate at 3% |
| ++ | +++ | SP 2 coated with asphalt treated with |
| | | Cupric Sulfate at 3% |
| ++++ | ++++ | SP 3 coated with asphalt treated with |
| | | Cupric Sulfate at 3% |
| ++++ | ++++ | CEI treated Kraft paper^{(c)} |
| ++++ | ++++ | CEI treated Kraft paper heated for 1½ |
| | | minutes in an oven at 350° F. |

^{(a)}a chlorinated phenoxy (Microban Products Company)
^{(b)}2-n-octyl-4-isothiazolin-3-one (Microban Products Company)
^{(c)}Kraft paper coated with polyethylene and carbon black and treated with a preservative

It was observed that SP 1 and SP 2, when treated, showed no mold growth. It was concluded that Microban LB-6, when used in conjunction with Kraft paper treated with 1-[[2-(2,4-dichloropheyl)4-propyl-1,3-diololan-2-yl]-methyl]-1H-1,2,4-triazole (Microban® S2140), α-(2-(4-chlorphenyl)ethyl)-α-(1-1-dimethylethyl)-1H-1,2,4-triazole-1-ethanol (Microban® S2142), and alkyl dimethylbenzyl ammonium saccharinate (Microban® S2176) is an effective biocide in reducing fungal growth on asphalt and paper.

### Example 11

### Testing of Treated Asphalt for Fungal Resistance According to ASTM C1338

Treated and untreated asphalt samples (shown in Table 14) were tested according to ASTM 1338 to determine if the samples could support fungal growth.

Aspergillus niger (American Type Culture Collection (ATCC) 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (treated and untreated asphalt) and comparative controls (white Birch tongue depressors (20×150 mm in size)). Duplicate samples were tested.

After pre-conditioning, the test samples and controls were inoculated with the mixed fungal spore suspension. Inoculation was accomplished by spraying the suspension in the form of a fine mist from an atomizer. The test materials were sprayed until the initiation of droplet coalescence. Incubation was conducted at 86±4° F. and a relative humidity of 95±4% for a time period of 28 days.

The inoculum and controls were examined after seven days of incubation. The samples and comparative controls were evaluated on incubation day 28 using a binocular stereoscopic microscope at 160× magnification. All fungal strain viability controls and the inoculum after 7 and 28 days of incubation showed copious amounts of fungal growth indicating a valid fungal resistance test. The comparative Birch controls showed slight fungal growth covering 80% of the surface area (++growth).

Microscopic examination of the test samples was conducted after 28 days of incubation. The standard for determining a rating of the fungal growth on the samples is set forth in Table 13. The observation results are set forth in Table 14.

TABLE 13

| Amount of Growth | Rating |
|---|---|
| No Growth | 0 |
| Scant Growth | + |
| Moderate Growth | ++ |
| Heavy Growth | +++ |
| Confluent Growth Over | ++++ |
| Entire Surface | |

TABLE 14

| Amount of | Amount of | |
|---|---|---|
| Growth | Growth | |
| On Asphalt | On Kraft Paper | Material |
| ++ | +++ | Untreated Kraft paper coated with |
| | | untreated asphalt |
| 0 | 0 | Untreated Kraft paper coated with |
| | | asphalt treated with |
| | | 2000 ppm Microban LB-6^{(a)} |
| + | 0 | SP 1 coated with asphalt |
| | | (no treatment) |
| + | 0 | SP 1 coated with asphalt treated with |
| | | 250 ppm Microban LB-6 |
| + | 0 | SP 1 coated with asphalt treated with |
| | | 500 ppm Microban LB-6 |
| 0 | 0 | SP 1 coated with asphalt treated with |
| | | 1000 ppm Microban LB-6 |
| 0 | 0 | SP 1 coated with asphalt treated with |
| | | 1500 ppm Microban LB-6 |
| 0 | 0 | SP 1 coated with asphalt treated with |
| | | 2000 ppm Microban LB-6 |
| 0 | 0 | SP 1 coated with asphalt treated with |
| | | Microban M-15^{(b)} at 2000 ppm |
| ++ | 0 | SP 2 coated with asphalt treated with |
| | | Microban M-15 at 2000 ppm |
| 0 | 0 | SP 3 coated with asphalt treated with |
| | | Microban M-15 at 2000 ppm |
| 0 | 0 | SP 1 coated with asphalt treated with |
| | | Microban M-15 at 3000 ppm |
| 0 | 0 | SP 2 coated with asphalt treated with |
| | | Microban M-15 at 3000 ppm |
| + | ++ | SP 3 coated with asphalt treated with |
| | | Microban M-15 at 3000 ppm |

^{(a)}2-n-octyl-4-isothiazolin-3-one (Microban Products Company)
^{(b)}tetrachloroisophthalonitrile (Microban Products Company)

Treated asphalt samples that contained less growth than the control (Birch tongue depressor) were considered to have passed the test. It was observed that all of the samples, with the exception of the untreated asphalt, had less mold growth than the control. Thus, it was concluded that asphalt treated with Microban M-15 and Microban LB-6 passed the test standards according to ASTM C1338 and showed little or no fungal growth.

### Example 12

### Testing of Treated Asphalt for Fungal Resistance According to ASTM G21

Various treated asphalt samples (shown in Table 16) were tested according to ASTM G21 to determine if the samples could support fungal growth. Spore suspensions of Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233) were prepared and tested for viability. Nutrient salts agar was poured into sterile dishes to provide a solidified agar layer from 3-6 mm in depth. The nutrient salts agar contained agar, ammonium nitrate, ferrous sulfate, magnesium sulfate, manganous sulfate, potassium dihydrogen orthophosphate, potassium monohydrogen orthophosphate, sodium chloride, and water. All tests were run in duplicate.

After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope. The standard for determining a rating of the fungal growth on the samples is set forth in Table 15. The observation results are set forth in Table 16.

TABLE 15

| Amount of Growth | Rating |
|---|---|
| None | 0 |
| Traces of Growth | + |
| (less than 10%) | |
| Light Growth | ++ |
| (10-30%) | |
| Medium Growth | +++ |
| (30-60%) | |
| Heavy Growth | ++++ |
| (60% to complete coverage) | |

TABLE 16

| Amount of | Amount of | |
|---|---|---|
| Growth | Growth | |
| On Asphalt | On Kraft Paper | Material |
| ++++ | ++++ | Untreated Kraft paper coated with |
| | | untreated asphalt |
| +++ | ++++ | Untreated Kraft paper coated with |
| | | asphalt treated with |
| | | 2000 ppm Microban LB-6^{(a)} |
| ++ | ++++ | SP 1 coated with asphalt |
| | | (no treatment) |
| 0, 0, + | 0, 0, + | SP 1 coated with asphalt treated with |
| | | 250 ppm Microban LB-6 |
| 0, 0, + | 0, +, ++ | SP 1 coated with asphalt treated with |
| | | 500 ppm Microban LB-6 |
| 0 | +, +, 0 | SP 1 coated with asphalt treated with |
| | | 1000 ppm Microban LB-6 |
| 0 | 0 | SP 1 coated with asphalt treated with |
| | | 1500 ppm Microban LB-6 |
| 0 | 0 | SP 1 coated with asphalt treated with |
| | | 2000 ppm Microban LB-6 |
| ++ | +++ | SP 1 coated with asphalt treated with |
| | | Microban M-15^{(b)} at 2000 ppm |
| ++ | +++ | SP 2 coated with asphalt treated with |
| | | Microban M-15 at 2000 ppm |
| +++ | ++++ | SP 3 coated with asphalt treated with |
| | | Microban M-15 at 2000 ppm |
| + | ++ | SP 1 coated with asphalt treated with |
| | | Microban M-15 at 3000 ppm |
| ++ | ++++ | SP 2 coated with asphalt treated with |
| | | Microban M-15 at 3000 ppm |
| ++++ | ++++ | SP 3 coated with asphalt treated with |
| | | Microban M-15 at 3000 ppm |

^{(a)}2-n-octyl-4-isothiazolin-3-one (Microban Products Company)
^{(b)}tetrachloroisophthalonitrile (Microban Products Company)

It was observed that SP 1 treated paper used in conjunction with Microban LB-6 at concentrations of 1500 ppm and 2000 ppm prevented fungal growth on the Kraft paper. Lower concentrations of Microban LB-6 (500 ppm, 1000 ppm) demonstrated little to no fungal growth. Thus it was concluded that Microban LB-6 was an effective antimicrobial agent for asphalt.

### Example 13

### Testing of Kraft Paper and Treated Asphalt for Fungal Resistance According to ASTM C1338

Kraft paper and treated asphalt samples as shown in Table 18 were tested according to ASTM C-1338. Aspergillus niger (ATCC 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (Kraft paper and treated asphalt) and comparative controls (white Birch tongue depressors (20×150 mm in size)). Duplicate samples were tested.

The samples and controls were inoculated with the mixed fungal spore suspension after pre-conditioning. Inoculation was accomplished by spraying the suspension in the form of a fine mist from an atomizer. The test materials were sprayed until the initiation of droplet coalescence. Incubation was conducted for 28 days at 86±4° F. and a relative humidity of 95±4%.

The inoculum and strain controls were examined after seven days of incubation. The samples and comparative controls were evaluated on the 28th day of testing using a binocular stereoscopic microscope at 160× magnification. All fungal strain viability controls and the inoculum after 7 and 28 days of incubation showed copious amounts of fungal growth indicating a valid fungal resistance test. The comparative Birch controls showed slight fungal growth covering 80% of the surface area (++growth).

Microscopic examination of the oxidized asphalt test samples was conducted after 28 days of incubation. The standard for determining a rating of the fungal growth on the samples is set forth in Table 17. The observation results are set forth in Table 18.

TABLE 17

| Amount of Growth | Rating |
|---|---|
| No Growth | 0 |
| Scant Growth | + |
| Moderate Growth | ++ |
| Heavy Growth | +++ |
| Confluent Growth Over | ++++ |
| Entire Surface | |

TABLE 18

| Amount of | Amount of | |
|---|---|---|
| Growth | Growth | |
| On Asphalt | On Kraft Paper | Material |
| 0 | ++ | Kraft paper treated on both |
| | | sides with |
| | | Metasol TK 25AD^{(a)} at 1000-1100 ppm |
| ++ | 0 | Kraft paper treated with |
| | | Metasol TK 25AD |
| | | (at 1000-1100 ppm) |
| | | coated with asphalt |
| 0 | 0 | Kraft paper treated with |
| | | Metasol TK 25AD coated |
| | | with asphalt treated with |
| | | Microban LB-6^{(b)} at 2000 ppm |

^{(a)}2-(4-thiazolyl)benzimidazole (commercially available from Bayer)
^{(b)}2-n-octyl-4-isothiazolin-3-one (Microban Products Company)

It was observed that all of the samples contained less growth than the control (Birch tongue depressor) and were therefore considered to have passed the standards according to ASTM 1338. It was also concluded that treating the asphalt with Microban LB-6 further improved mold resistance.

### Example 14

### Testing of Kraft Paper and Treated Asphalt for Fungal Resistance According to ASTM G21

The testing of Kraft paper and treated asphalt samples was conducted according to ASTM G21.

Spore suspensions of Aspergillus niger (ATCC 9642), Penicillium pinophilum (ATCC 11797), Chaetomium globosum (ATCC 6205), Gliocladium virens (ATCC 9645) and Aureobasidium pullulans (ATCC 15233) were prepared and tested for viability. Nutrient salts agar was poured into sterile dishes to provide a solidified agar layer from 3-6 mm in depth. The nutrient salts agar contained agar, ammonium nitrate, ferrous sulfate, magnesium sulfate, manganous sulfate, potassium dihydrogen orthophosphate, potassium monohydrogen orthophosphate, sodium chloride, and water. After the agar was solidified, the specimens were placed on the surface of the agar. The surfaces of the test specimens were sprayed with the composite spore suspension. The inoculated test specimens were incubated at 28-30° C. at a relative humidity of not less than 85%. The specimens were examined using a 40× microscope.

The standard for determining a rating of the fungal growth on the asphalt and Kraft paper is set forth in Table 19. The observation results are set forth in Table 20.

TABLE 19

| Amount of Growth | Rating |
|---|---|
| None | 0 |
| Traces of Growth | + |
| (less than 10%) | |
| Light Growth | ++ |
| (10-30%) | |
| Medium Growth | +++ |
| (30-60%) | |
| Heavy Growth | ++++ |
| (60% to complete coverage) | |

TABLE 20

| Amount of | Amount of | |
|---|---|---|
| Growth | Growth | |
| On Asphalt | On Kraft Paper | Material |
| | 0 | Kraft paper treated on both |
| | | sides with |
| | | Metasol TK 25AD^{(a)} at 1000-1100 ppm |
| 0 | 0 | Kraft paper treated with |
| | | Metasol TK 25AD |
| | | (at 1000-1100 ppm) |
| | | coated with asphalt |
| 0 | 0 | Kraft paper treated with |
| | | Metasol TK 25AD coated |
| | | with asphalt treated with |
| | | Microban LB-6^{(b)} at 2000 ppm |

^{(a)}2-(4-thiazolyl)benzimidazole (commercially available from Bayer)
^{(b)}2-n-octyl-4-isothiazolin-3-one (Microban Products Company)

It was observed that none of the test samples supported any fungal growth. Thus, the samples were considered to have passed the testing standards set forth in ASTM G21.

### Example 15

### Testing of Kraft Paper for Fungal Resistance According to ASTM C1338

Untreated Kraft paper and Kraft paper treated with Metasol TK 25AD were tested for fungal resistance according to ASTM 1338.

Aspergillus niger (ATCC 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples (treated and untreated Kraft paper) and comparative controls (white Birch tongue depressors (20×150 mm in size)). Duplicate samples were tested.

The samples and controls were inoculated with the mixed fungal spore suspension after pre-conditioning. Inoculation was accomplished by spraying the suspension in the form of a fine mist from an atomizer. The test materials were sprayed until the initiation of droplet coalescence. Incubation was conducted for 28 days at 86±4° F. and a relative humidity of 95±4%. The inoculum and strain controls were examined after seven days of incubation. The samples and comparative controls were evaluated on the 28th day of testing using a binocular stereoscopic microscope at 160× magnification.

Microscopic examination of the Kraft paper samples was conducted after 28 days of incubation. The results are set forth in Table 21.

TABLE 21

| | Amount of Growth | Amount of Growth |
|---|---|---|
| Sample Description | Without Nutrient | With Nutrient |
| Untreated | + | ++ |
| Kraft paper | | |
| Kraft paper treated | 0 | 0 |
| with Metasol | | |
| TK 25AD^{(a)} | | |

^{(a)}2-(4-thiazolyl)benzimidazole (commercially available from Bayer)

It was observed that both the untreated and treated Kraft paper showed less fungal growth than the Birch tongue depressor control. Thus it was concluded that both the treated and untreated Kraft paper passed the test standards set forth in ASTM 1338. It was also observed that the treated Kraft paper provided for less fungal growth when additional nutrient is present.

### Example 16

### Testing of Insulation Materials for Fungal Resistance According to ASTM 1338

The testing of (1) Asphalt coated Kraft paper treated on one side (medium level), (2) Asphalt coated Kraft paper treated with Metasol TK 25AD on both sides, and (3) untreated insulation was conducted according to ASTM C1338.

Aspergillus niger (ATCC 9642), Aspergillus versicolor (ATCC 11730), Chaetomium globosum (ATCC 6205), Aspergillus flavus (ATCC 9643) and Penicillium funiculosum (ATCC 11797) were harvested and the viability of each fungal culture was confirmed. The five fungal cultures were used to prepare a mixed spore suspension. Inoculum viability controls were inoculated along with the test samples and comparative controls (white Birch tongue depressors (20×150 mm in size).

The samples and controls were inoculated with the mixed fungal spore suspension after pre-conditioning. Inoculation was accomplished by spraying the suspension in the form of a fine mist from an atomizer. The test materials were sprayed until the initiation of droplet coalescence. Incubation was conducted for 28 days at 86±4° F. and a relative humidity of 95±4%.

The inoculum and strain controls were examined after seven days of incubation. The samples and comparative controls were evaluated on the 28th day of testing using a binocular stereoscopic microscope at 160× magnification. All fungal strain viability controls and the inoculum after 7 and 28 days of incubation showed copious amounts of fungal growth indicating a valid fungal resistance test. The comparative Birch controls showed slight fungal growth covering 80% of the surface area (++growth).

Microscopic examination of the oxidized asphalt test samples was conducted after 28 days of incubation. The standard for determining a rating of the fungal growth on the samples is set forth in Table 22. The observation results are set forth in Tables 23-25.

TABLE 22

| Amount of Growth | Rating |
|---|---|
| No Growth | 0 |
| Scant Growth | + |
| Moderate Growth | ++ |
| Heavy Growth | +++ |
| Confluent Growth Over | ++++ |
| Entire Surface | |

TABLE 23

| Amount of | Amount of | |
|---|---|---|
| Growth | Growth | |
| On Kraft Paper | On Asphalt | Material |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |
| 0 | 0 | Asphalt coated Kraft paper treated |
| | | SP-1 on one side (Medium level) |

(a) 2-(4-thiazolyl)benzimidazole (commercially available from Bayer)

TABLE 24

| Amount of | Amount of | |
|---|---|---|
| Growth | Growth | |
| On Kraft Paper | On Asphalt | Material |
| + | ++ | Untreated sample |
| ++ | ++ | Untreated sample |
| + | ++ | Untreated sample |
| ++ | ++ | Untreated sample |
| ++ | ++ | Untreated sample |
| ++ | ++ | Untreated sample |
| ++ | ++ | Untreated sample |
| ++ | ++ | Untreated sample |
| ++ | ++ | Untreated sample |
| ++ | ++ | Untreated sample |

TABLE 25

| Amount of | Amount of | |
|---|---|---|
| Growth | Growth | |
| On Kraft Paper | On Asphalt | Material |
| 0 | + | Asphalt coated Kraft paper |
| | | treated with Metasol TK |
| | | 25AD^{(a)} on both sides |
| + | 0 | Asphalt coated Kraft paper |
| | | treated with Metasol TK |
| | | 25AD on both sides |
| 0 | + | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |
| 0 | 0 | Asphalt coated Kraft paper |
| | | treated with Metasol TK |
| | | 25AD on both sides |

^{(a)}2-(4-thiazolyl)benzimidazole (commercially available from Bayer)

It was observed that the asphalt coated Kraft paper samples showed little to scant fungal growth. It was also observed that all of the samples contained no more fungal growth than the Birch tongue depressor control. The untreated samples supported fungal growth to the same extent as the control (i.e., ++growth). Samples that showed fungal growth no greater than the control was considered to have passed the test standards according to ASTM C1338. Thus it was concluded that all of the samples tested passed the ASTM 1338 fungal resistance test. It was also concluded that treated Kraft paper samples exhibited a statistically significant difference in the resistance to mold growth over the untreated Kraft paper samples.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method for inhibiting the growth of microorganisms in a fiberglass insulation product including a plurality of randomly oriented glass fibers forming a fibrous insulation batt and a facing on a major surface of said fibrous insulation batt, said method comprising the step of:
applying a first biocidally effective amount of an anti-microbial composition to at least one surface of said facing of said insulation product.

2. The method of claim 1, wherein said anti-microbial composition comprises one or more anti-microbial compounds selected from the group consisting of 1-[[2-(2,4-dichloropheyl)4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol, alkyl dimethylbenzyl ammonium saccharinate, zinc 2-pyrimidinethiol-1-oxide, 1-[2-(3,5-dichloro-phenyl)-4-propyl-[1,3]dioxolan-2-ylmethyl]-1H-[1,2,4]triazole, 4,5-dichloro-2-octyl-isothiazolidin-3-one, 2-octyl-isothiazolidin-3-one, 2-octyl-isothiazolidin-3-one, 5-chloro-2-(2,4-dichloro-phenoxy)-phenol, 2-thiazol-4-yl-1H-benzoimidazole, 1-(4-chloro-phenyl)-4,4-dimethyl-3-[1,2,4]triazol-4-ylmethyl-pentan-3-ol, 10,10′ oxybisphenoxarsine and 1-(diiodo-methanesulfonyl)-4-methyl-benzene.

3. The method of claim 2, wherein each said anti-microbial compound is present in said anti-microbial composition in an amount of from 50-1000 ppm.

4. The method of claim 3, wherein said anti-microbial composition comprises 1-[[2-(2,4-dichloropheyl)4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol and alkyl dimethylbenzyl ammonium saccharinate.

5. The method of claim 4, wherein said facing is Kraft paper.

6. The method of claim 2, further comprising the step of:
adding 2-(4-thiazolyl)benzimidazole to said anti-microbial composition as a biocidal agent.

7. The method of claim 2, further comprising the step of:
treating asphalt with a second biocidally effective amount of at least one anti-microbial agent capable of surviving temperatures of at least 350° F., said asphalt adhering said facing to said fibrous insulation batt.

8. The method of claim 7, wherein said at least one anti-microbial agent is selected from the group consisting of 2-n-octyl-4-isothiazolin-3-one, zinc 2-pyrimidinethiol-1-oxide, 1-[2-(3,5-dichloro-phenyl)-4-propyl-[1,3]dioxolan-2-ylmethyl]-1H-[1,2,4]triazole and 1-(diiodo-methanesulfonyl)-4-methyl-benzene.

9. The method of claim 7, wherein said second biocidally effective amount is an amount from 200-3000 ppm.

10. A fiberglass insulation product comprising:
a plurality of randomly oriented glass fibers forming a fibrous insulation batt; and
a facing on a major surface of said fibrous insulation batt, said facing including an anti-microbial composition on at least a portion of a surface thereof.

11. The fiberglass insulation product of claim 10, wherein said anti-microbial composition includes one or more anti-microbial compounds selected from the group consisting of 1-[[2-(2,4-dichloropheyl)4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol, alkyl dimethylbenzyl ammonium saccharinate, zinc 2-pyrimidinethiol-1-oxide, 1-[2-(3,5-dichloro-phenyl)-4-propyl-[1,3]dioxolan-2-ylmethyl]-1H-[1,2,4]triazole, 4,5-dichloro-2-octyl-isothiazolidin-3-one, 2-octyl-isothiazolidin-3-one, 2-octyl-isothiazolidin-3-one, 5-chloro-2-(2,4-dichloro-phenoxy)-phenol, 2-thiazol-4-yl-1H-benzoimidazole, 1-(4-chloro-phenyl)-4,4-dimethyl-3-[1,2,4]triazol-4-ylmethyl-pentan-3-ol, 10,10′ oxybisphenoxarsine and 1-(diiodo-methanesulfonyl)-4-methyl-benzene.

12. The fiberglass insulation product of claim 11, wherein said anti-microbial composition comprises 1-[[2-(2,4-dichloropheyl)4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol, and alkyl dimethylbenzyl ammonium saccharinate.

13. The fiberglass insulation product of claim 12, wherein said anti-microbial composition further includes 2-(4-thiazolyl)benzimidazole as a biocidal agent.

14. The fiberglass insulation product of claim 12, wherein each said anti-microbial compound in said anti-microbial composition is present in an amount of from 50-1000 ppm.

15. The fiberglass insulation product of claim 11, further comprising:
a layer of asphalt positioned between said facing and said insulation batt, said asphalt being treated with at least one anti-microbial agent capable of surviving temperatures of at least 350° F.

16. The fiberglass insulation product of claim 15, wherein said at least one anti-microbial agent comprises one or more anti-microbial agents selected from the group consisting of 2-n-octyl-4-isothiazolin-3-one, zinc 2-pyrimidinethiol-1-oxide, 1-[2-(3,5-dichloro-phenyl)-4-propyl-[1,3]dioxolan-2-ylmethyl]-1H-[1,2,4]triazole and 1-(diiodo-methanesulfonyl)-4-methyl-benzene.

17. The fiberglass insulation product of claim 16, wherein said at least one anti-microbial agent is present on said asphalt in an amount of from 200-3000 ppm.

18. A fiberglass insulation product comprising:
a plurality of randomly oriented glass fibers forming a fibrous insulation batt;
a non-woven facing positioned on a major surface of said fibrous insulation batt; and
a layer of asphalt disposed between said fibrous insulation batt and said non-woven facing; and
wherein at least one of said non-woven facing and said layer of asphalt is treated with a biocidally effective amount of at least one anti-microbial agent.

19. The fiberglass insulation product of claim 18, wherein said non-woven facing is treated with at least one anti-microbial compound selected from the group consisting of 1-[[2-(2,4-dichloropheyl)4-propyl-1,3-diololan-2-yl]-methyl]-1H-1,2,4-triazole, α-(2-(4-chlorphenyl)ethyl)-α-(1-1-dimethylethyl)-1H-1,2,4-triazole-1-ethanol and alkyl dimethylbenzyl ammonium saccharinate.

20. The fiberglass insulation product of claim 19, wherein said each said anti-microbial compound is present in an amount of from 50-1000 ppm.

21. The fiberglass insulation product of claim 18, wherein said layer of asphalt is treated with one or more anti-microbial agents selected from the group consisting of 2-n-octyl-4-isothiazolin-3-one, zinc 2-pyrimidinethiol-1-oxide, 1-[2-(3,5-dichloro-phenyl)-4-propyl-[1,3]dioxolan-2-ylmethyl]-1H-[1,2,4]triazole and 1-(diiodo-methanesulfonyl)-4-methyl-benzene.

22. The fiberglass insulation product of claim 21, wherein said at least one anti-microbial agent is present in an amount of from 200-3000 ppm.

23. The fiberglass insulation product of claim 19, wherein said non-woven facing is further treated with 2-(4-thiazolyl)benzimidazole as a biocidal agent.
